(19) United States
(12) Patent Application Publication
(10) Pub. No.: US 2026/0046021 A1
(43) Pub. Date: Feb. 12, 2026

(54) Management of an Interface of a Satellite Network Between a Wireless Device and a Service Provider

(71) Applicant: Skylo Technologies, Inc., Mountain View, CA (US)

(72) Inventors: Arjun Nandal, Tampa, FL (US); Meghna Agrawal, Cupertino, CA (US); Soham Dhiren Desai, Palo Alto, CA (US); Anteneh Adem, Espoo (FI); Andrew Nuttall, Mountain View, CA (US)

(73) Assignee: Skylo Technologies, Inc., Mountain View, CA (US)

(21) Appl. No.: 19/087,477

(22) Filed: Mar. 22, 2025

Related U.S. Application Data
(60) Provisional application No. 63/679,709, filed on Aug. 6, 2024.
(60) Provisional application No. 63/711,099, filed on Oct. 23, 2024.

(51) Int. Cl. H04B 7/185; H04L 65/1073; H04L 65/1104; H04L 65/65

(52) U.S. Cl. CPC H04B 7/18539; H04L 65/1073; H04L 65/1104; H04L 65/65

(57) ABSTRACT

Apparatuses, methods, and systems for managing an interface of a satellite network between a wireless device and a service provider are disclosed. One method includes receiving through a satellite link, by a service gateway of the satellite network, a wireless device trigger message from the wireless device, wherein the satellite network includes a base station and a satellite core network, and performing, by the service gateway of the satellite network, session establishment of the wireless device with the service provider when receiving the wireless device trigger message, including modifying the wireless device trigger message to include additional data required by the service provider.

### RELATED PATENT APPLICATIONS

This patent application claims the benefit of U.S. Provisional Patent Application Ser. No. 63/711,099 filed Oct. 23, 2024, and the benefit of U.S. Provisional Patent Application Ser. No. 63/679,709 filed Aug. 6, 2024, which are herein incorporated by reference.

### FIELD OF THE DESCRIBED EMBODIMENTS

The described embodiments relate generally to wireless communications. More particularly, the embodiments described relate to systems, methods, and apparatuses for management of an interface of a satellite network between a wireless device and a service provider.

### BACKGROUND

With the advent of advanced communication technologies, there is a growing need for seamless and efficient integration of different communication services.

It is desirable to have methods, apparatuses, and systems for management of an interface of a satellite network between a wireless device and a service provider.

### SUMMARY

An embodiment includes a method of managing an interface of a satellite network between a wireless device and a service provider. The method includes receiving through a satellite link, by a service gateway of the satellite network, a wireless device trigger message from the wireless device, wherein the satellite network includes a base station and a satellite core network, and performing, by the service gateway of the satellite network, session establishment of the wireless device with the service provider when receiving the wireless device trigger message, including modifying the wireless device trigger message to include additional data required by the service provider.

Another embodiment includes a satellite network. The satellite network includes a satellite, a base station configured to communicate with a wireless device through the satellite, and a service gateway. The service gateway is configured to receive a wireless device trigger message through a satellite link formed between the wireless device and the satellite, and perform session establishment of the wireless device with a service provider when receiving the wireless device trigger message, including modifying the wireless device trigger message to include additional data required by the service provider.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1A shows a satellite network that manages an interface between a wireless device and a service provider, according to an embodiment.

FIG. 1B shows a satellite network that manages an interface between a wireless device and a service provider, according to another embodiment.

FIG. 2 shows a wireless device wirelessly connected to a service gateway through a low bandwidth channel, and a wireless device connected to the service gateway through a high bandwidth channel, according to an embodiment.

FIG. 3 shows a satellite network that manages an interface between a wireless device and a service provider, according to another embodiment.

FIG. 4 is a flow chart that includes steps of a method for a satellite network managing an interface between a wireless device and a service provider according to an embodiment.

FIG. 5 shows a timeline of establishing, by the voice manager, SIP (Session Initiation Protocol) or SS7 (Signaling System No. 7) registration for the wireless device with a 3GPP IMS (IP Multimedia Subsystem) core network or SS7 network, according to an embodiment.

FIG. 6 shows a timeline of maintaining, by a voice manager of a service gateway 630, session continuity by exchanging periodic signaling messages between a wireless device 610 and the service provider 540, according to an embodiment.

FIG. 7 shows a timeline of managing the interface of the satellite network between the wireless device and the service provider, and the codec transcoding by the voice manager according to an embodiment.

FIG. 8 shows a timeline of exchanging, by a voice manager of a service gateway, media parameters during session negotiation using SDP, ensuring compatibility between low-bandwidth NB-IoT codecs and terrestrial IMS codecs, according to an embodiment.

FIG. 9 shows a timeline of synchronization, by the base station, session QoS (quality of service) management operations between the voice manager and the wireless device, ensuring seamless end-to-end communication, according to an embodiment.

FIG. 10 shows a timeline of managing session initiation in a satellite-based network, according to an embodiment.

FIG. 11 shows a timeline of negotiating codecs for media transmission during session setup, according to an embodiment.

FIG. 12 shows a timeline of termination of a session between the wireless device and the service provider, according to an embodiment.

FIG. 13 shows a timeline of translating lightweight protocol messages into SIP-compliant messages and vice versa, according to an embodiment.

FIG. 14 shows a timeline of translating, by the voice manager, low-bandwidth codecs into standard codecs, according to an embodiment.

FIG. 15 shows processes between the voice manager and the service provider core components during registration and session maintenance, according to an embodiment.

FIG. 16 shows message protocols and messages used between the wireless device, the base station, the voice manager, and 3GPP IMS/SBC, according to an embodiment.

### DETAILED DESCRIPTION

The embodiments described include methods, apparatuses, and systems for management of an interface of a satellite network between a wireless device and a service provider.

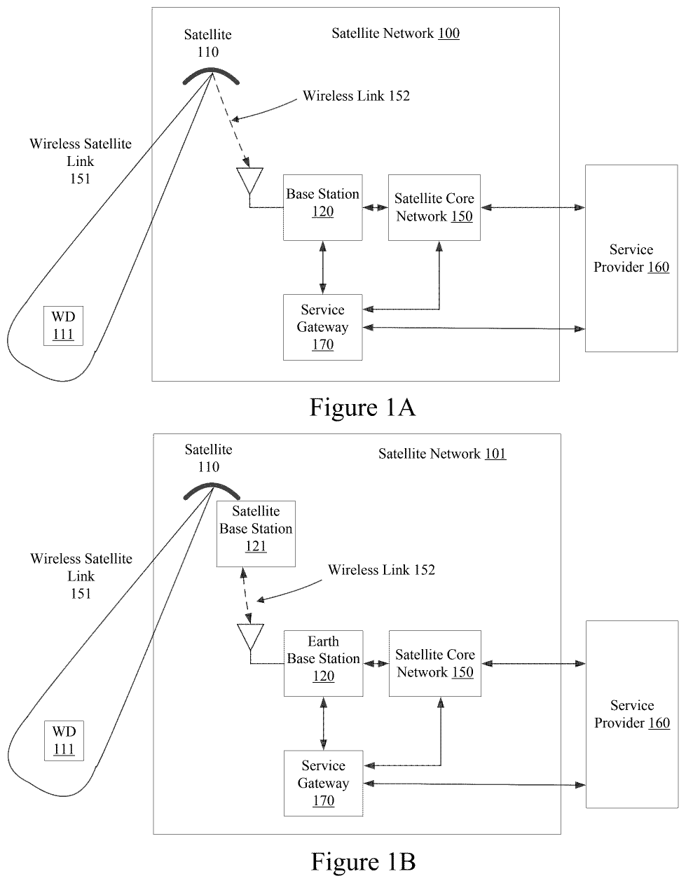

FIG. 1A shows a satellite network 100 that manages an interface between a wireless device 111 and a service provider 160, according to an embodiment. As shown, a wireless device 111 communicates with base station 120 of the satellite network 100 through wireless links 151, 152. The satellite network 100 includes a satellite 110, the base station 120, a service gateway 170, and a satellite core network 150.

FIG. 1B shows a satellite network 101 that manages an interface between a wireless device 111 and a service provider 160, according to another embodiment. The embodiment of FIG. 1B shows at least some of the base station functionality included as a separate base station 121 co-located with the satellite 110. It is to be understood that the functionality of the service gateway is the same for the embodiments of both FIG. 1A and FIG. 1B.

For an embodiment, the service gateway 170 of the satellite network 100, 101 is configured to receive through a satellite link (links 151, 152) a wireless device trigger message from the wireless device 111, wherein the satellite network 100, 101 includes the base station 120 and the satellite core network 150. Further, for an embodiment, the service gateway 170 is configured to perform session establishment of the wireless device 111 with the service provider 160 when receiving the wireless device trigger message, including modifying the wireless device trigger message to include additional data required by the service provider 160. It is to be understood that for an embodiment, the service gateway 170 acts as a proxy for the wireless device 111 by registering the wireless device 111 with the service provider 160 on behalf of the wireless device 111.

For an embodiment, the service gateway 170 receiving through the satellite link the wireless device trigger message from the wireless device 111 includes a voice manager of the service gateway 170 receiving a lightweight protocol INVITE message transmitted from the wireless device 111. For an embodiment, the satellite link is facilitated by the base station 120 which may include a gNodeB-5G (gNodeB (Next Generation Node B)-5G base station) or an eNodeB-4G (eNodeB (Evolved Node B)-4G base station) configured to interface with the wireless device 111. For an embodiment, the base station 120 and the voice manager of the service gateway are two components of the satellite communication network.

For an embodiment, the service gateway 170 performing the session establishment of the wireless device 111 with the service provider 160 when receiving the wireless device trigger message includes translating, by the voice manager of the service gateway 170, the lightweight protocol INVITE message (for this embodiment INVITE message is the trigger message) into a (an IMS (IP Multimedia Subsystem) or Non-IMS) Session Initiation Protocol (SIP) INVITE message, wherein the voice manager is implemented within the satellite core network 150 to enable compatibility with the service provider 160, and the voice manager further implements a translation between lightweight protocol and 3GPP-defined CS-Voice/IMS-SIP protocols to enable compatibility with the service provider 160. For an embodiment, the voice manager of the service gateway 170 is responsible for registering the wireless device 111 with the service provider 160. If the voice manager receives a lightweight trigger message from the wireless device 111 and wireless device 111 is not already registered with the service provider 160, then voice manager 160 initiates the registration process with the service provider 160.

After the registration process is done, the voice manager starts the service initiation process with the service provider. Voice manager creates or translates a SIP invite message, based on the information received in the lightweight protocol trigger message and wireless device information stored in the voice manager database and sends it to the service provider. The wireless device information stored in the voice manager database includes the wireless device context saved during registration, APNs and service capability associated with the wireless device, IP address and other identifiers associated with the wireless device including IMSI.

For an embodiment, the lightweight protocol INVITE message is an embodiment of the trigger message. For this embodiment, the trigger message is used to initiate a voice call from the wireless device 111. For an embodiment, in order to initiate voice call, the wireless device 111 uses a lightweight protocol agreed between wireless device 111 and voice manager of the satellite gateway 170. For an embodiment, the lightweight protocol includes an ‘INVITE’ message which is used to initiate the voice call by the wireless device 111.

For an embodiment, the Session Initiation Protocol (SIP) of the INVITE message is a standard protocol used for session establishment for a voice call over LTE (long term evolution). For an embodiment, the SIP Invite message is used to initiate the call by the wireless device 111 when operating on an LTE network. For an embodiment, the voice manager of service gateway 170 translates the lightweight INVITE message into a SIP INVITE message for establishing a session with service provider 160.

For an embodiment, the 3GPP-defined CS-Voice/IMS-SIP protocols of the service provider 160 is implemented by an existing service provider that uses circuit-switch (CS) or an IMS (IP multimedia services) architecture for voice session establishment. For an embodiment, the voice manager of the service gateway 170 translates LWP (lightweight protocol) INVITE into SIP INVITE and connects to the service provider 160 using a circuit-switch or an IMS architecture.

For an embodiment, SIP is an example of a protocol used by voice manager to connect with the service provider 160. For an embodiment, when supporting an over-the-top voice call (OTT voice call) the voice manager can convert the lightweight protocol into a custom OTT voice protocol supported by the service provider. An over-the-top (OTT) voice call is a voice call that uses the internet to connect callers. OTT voice calls are also known as VoIP (Voice over Internet Protocol) calls.

For an embodiment, for voice services, the voice manager establishes a session with the service provider 160, wherein the service provider 160 can be an MNO (mobile virtual network operator), MVNO (mobile network operator), or OTT (over the top) voice service provider (such as Whatsapp®). For an embodiment, while establishing connection with an OTT service provider, voice manager translates the lightweight protocol into a custom protocol agreed between the voice gateway and OTT service provider.

### Wireless Device Trigger Message

For an embodiment, the wireless device trigger message does not include at least some mandatory data required by the service provider 160 for session establishment with the service provider 160. For an embodiment, the service gateway of the satellite network 100, 101 supplements the wireless device trigger message with the mandatory data. For an embodiment, supplementing wireless device trigger messages can include two parts. A first part includes information collected from the wireless device trigger message (such as, device identity, calling party ID, message ID), and the second part includes a specific protocol structure as required by the service provider 160. For an embodiment, the service gateway 170 also collects information from the wireless device 111 until the service gateway 170 gets all the information service gateway 170 needs for establishing connection with the service provider 170. For an embodiment, the wireless device trigger message is a non-IP (internet protocol) message that is converted to an IP protocol message by the service gateway 170 for the service provider 160.

For an embodiment, the wireless device trigger message includes wireless device identification fields, and the service gateway 170 of the satellite network 100, 101 supplements the trigger message with the additional mandatory data using the wireless device identification fields. The wireless device identification fields may include, for example, IMSI, IMEI, TMSI identifiers. The identification fields provide information about the wireless device 111 for identification by the base station 120 and/or the satellite core network 150. For an embodiment, the service gateway 170 uses the identifiers to identify a unique subscriber identity, to enable making and receiving calls, to enable a network to be able to route incoming and outgoing calls. The identifiers may include MSISDN, MSRN, UE-IP, Profile (MO/MT Capability etc.). MSISDN is the mobile number of the user (wireless device_and is used to make/receive a call. MSRN is the temporary number assigned by the network when a terminating call needs to be connected to the user in mobility. UE-IP is the IP given by our PGW to identify where this user is connected so that call can be routed. Profile refers to the profile of the user in HSS/HLR that allows the user the capability to make or receive calls. These attributes are used to identify, route and allow the calls to happen by the voice gateway. International Mobile Subscriber Identity (IMSI) is a unique identifier for a mobile phone subscriber, stored on the SIM card, used to authenticate the user on a mobile network. International Mobile Equipment Identity (IMEI) is unique identifier for a mobile device itself, like a smartphone, used to track stolen phones. Temporary Mobile Subscriber Identity (TMSI) is a temporary identifier used by the network to protect a subscriber's privacy by replacing their IMSI during communication.

### Satellite Core Network

For an embodiment, the satellite core network creates a tunnel between base station and service gateway which can be used to exchange control and data packets associated with a service.

### Service Provider

For an embodiment, the service provider is a mobile operator, and the mobile operator can include IMS services/circuit switch, or can be a platform based service provider (for example, a JIBE server). A JIBE server provides a technology platform for carriers to launch and operate carrier RCS services, delivering a better native messaging experience to users.

For an embodiment, the wireless device trigger message is transmitted by the wireless device 111 using a non-IP data transport layer, and wherein the mandatory data added by service gateway includes at least one of a TCP (Transmission Control Protocol) IP (internet protocol), a UDP (User Datagram Protocol) IP, or a SCTP (Stream Control Transmission Protocol) IP. For an embodiment, in order to convert non-IP packets to IP packets, voice manager maintains the wireless device and session context in its memory including source, destination IP address, packet sequence number and protocol version number supported by the service provider components.

At least some embodiments include the service gateway 170 being configured to convert the wireless device trigger message received from the wireless device into a 3GPP defined message. For at least some embodiments, the 3GPP message is more specifically an SS7 (Signaling System No. 7) message or an SIP multimedia message. For an embodiment, the service gateway 170 is configured to forward the 3GPP defined message to the service provider 160 after the registration is completed.

After registration of the wireless device 111 by the service gateway 160, at least some embodiments include the service gateway 170 being configured to receive through the satellite link wireless device communication messages from the wireless device 111, and converting the wireless device communication messages received from the wireless device into 3GPP defined messages. For at least some embodiments, the 3GPP messages are more specifically SS7 messages or SIP multimedia messages. For an embodiment, the service gateway 170 is configured to forward the 3GPP defined messages to the mobile carrier network after the registration is completed.

For an embodiment, the wireless device trigger message is used to initiate a voice call over an NB-IoT network. For an embodiment, the service gateway is configured to convert the mobile network trigger message received from the wireless device into a 3GPP defined (SIP protocol) voice trigger equivalent message (for example, the SIP INVITE Message). For an embodiment, fields are added when converting, for example, I1 to SIP. An SIP Call-ID may be added to generate the SIP message. The SIP Call-ID is a unique identifier for each SIP call. The Voice Gateway must generate a unique Call-ID for each I1 call that is being converted to SIP. For an embodiment, SIP From and To headers may be generated, wherein the headers include the addresses of the calling and called parties. For I1, the calling and called party numbers are carried in I1 messages. These numbers may need to be translated or formatted to SIP URIs (Uniform Resource Identifiers). For example, a mobile number might be converted to a sip: +15551234567'a'domain. com URI. For an embodiment, an SDP (Session Description Protocol) is generated, wherein the SDP is used to describe the media capabilities of the endpoints, such as codecs, ports, and IP addresses. However, I1 doesn't use SDP, and for an embodiment, the voice manager of the service gateway generates an SDP offer or answer based on the media capabilities of the SIP endpoint. For an embodiment, this includes the selection of the correct codec. The 3GPP network might be using AMR-WB codecs or other codecs. For an embodiment, the voice manager of the service gateway is capable of transcoding if those codecs are not compatible. For an embodiment, the voice manager of the service gateway allocates RTP (Real-time Transport Protocol) ports for the media stream and include these ports in the SDP, wherein the RTP is used to carry the actual media stream. I1 doesn't use RTP, and therefore, the voice manager of the service gateway allocates the RTP ports for the media stream and include these ports in the SDP. For an embodiment, the voice manager of the service gateway adds its own Via header to SIP messages that the voice manager generates. The SIP Via Header is used for loop detection and routing of SIP messages. For an embodiment, the voice manager of the service gateway generates and maintains CSeq (Command Sequence) values of a CSeq (Command Sequence) Header. For an embodiment, the CSeq Header is used to sequence SIP requests and responses. For an embodiment, the voice manager of the service gateway generates is own contact header. For an embodiment, the contact header provides a SIP URI that can be used to contact the sending endpoint. For an embodiment, the voice manager of the service gateway uses Content-Type and Content-Length headers when the voice manager adds an SDP body.

For an embodiment, the wireless device communicates messages uses a lightweight voice codec for voice packets, wherein service gateway converts the wireless device communication message received from the wireless device into voice packets using standard voice codecs supported by the service provider. For an embodiment, non-standard lightweight (low bandwidth) codecs can be used between wireless device and service gateway to support voice messaging and/or voice call over an Nb-IoT network. For an embodiment, the voice messages are transmitted using a non-Ip data path to minimize overhead and increase efficiency. For an embodiment, the service gateway 170 receives the wireless device communication messages, performs transcoding to convert voice packet from non-standard lightweight codec (for example, machine learning based lightweight codecs, such as, Codec2, NESC) to a codec which is supported by a receiving party (such as, AMR-WB). Here, the receiving party refers to the device which is receiving a voice message or voice call. For an embodiment, the receiving party is the service provider 160 or the end device receiving the voice call. For an embodiment, the service gateway 170 is configured to encapsulate the voice packets into standard format by adding the RTP and IP headers (for example, voice packets with RTP (real-time protocol, internet protocol). For an embodiment the lightweight voice protocol carrying voice media packets may not include any header. For an embodiment the base station provides additional information to the service gateway for encapsulating the voice packet into the standard format, including the receiver timestamp of the voice packet, the data-bearer ID and APN associated with the voice packet. For an embodiment, the base station can also provide the received signal strength and bit-error-rate of the voice packets to the service provider, which can be used by the service provider for predicting the voice quality. For an embodiment, the service gateway can also perform admission control functions based on voice quality predictions.

For an embodiment, the service gateway 170 is configured to receive a mobile network trigger message from the service provider 160. Further, for an embodiment, the service gateway 170 is configured to convert the mobile network trigger message received from the wireless device into a lightweight protocol equivalent message and forward the lightweight protocol equivalent message to the wireless device 111. As described, for an embodiment, the lightweight protocol equivalent message utilizes a non-IP data delivery path. For an embodiment, the non-IP data delivery path is associated by a specific APN (Access Point Name) For an embodiment, the service gateway 170 is configured to collect all needed information, convert the information into a protocol that the wireless device understands. For an embodiment, this can be a trigger for an MT (mobile terminated) call for the wireless device 111. For an embodiment, the mobile network trigger message triggers a start or a stop of a voice call or rich communication services like streaming. For an embodiment, the lightweight protocol can be used by the wireless device for voice call as well as rich services. Data streaming is an example of rich services supported by lightweight protocol.

For an embodiment, converting the mobile network trigger message received from the wireless device into the lightweight protocol equivalent message eliminates at least an IP header and other mandatory data required by terrestrial mobile networks to enable voice and multimedia communication. For an embodiment, in order to minimize the bandwidth required for a voice call, lightweight protocol eliminates the headers added to the voice packet including the IP header. For an embodiment, the satellite network uses ‘NIDD (Non-IP data delivery) over User Plane’ data transmission protocol to transmit voice packets over the air. For an embodiment, the satellite network assigns an IP for the wireless device which is used by service gateway to convert the voice packet into standard format. For an embodiment, the service gateway can maintain a database to maintain wireless device ID with the associated assigned IP address. The term “NIDD over user plane” refers to the concept of transmitting “Non-IP Data Delivery (NIDD)” data through the user plane of a cellular network, meaning the data is sent directly through the data channel used for regular user traffic, bypassing the standard IP protocol stack, which can be advantageous for low-power IoT devices that need to send small amounts of data infrequently by reducing overhead and power consumption.

For an embodiment, the wireless device trigger message is defined by a lightweight protocol between the wireless device and the service gateway, and functions of the service gateway include interworking between the lightweight protocol and a 3gpp SIP protocol, wherein interworking includes means that service gateway 170 can generate additional messages between the service gateway 170 and the service provider 160 to maintain the connection between wireless device 111 and service provider 160. For example, there can be periodic messages (which may be referred to as a progress message or a keep-alive message) between service gateway 170 and service provider 160 which indicates the availability of wireless device 111. For an embodiment, availability means that the wireless device 111 is still connected to the satellite network 100, 101 and is within reception range.

For an embodiment, the wireless device trigger message triggers a voice call, wherein the wireless device trigger message includes a session description protocol offer for negotiation, and the service gateway responds with a session description protocol answer. The session description protocol (SDP) which includes information like source and destination IP, CODEC supported, CODEC rates supported.

For an embodiment, the service gateway 170 is configured to convert SIP (session initiator protocol) responses received from the service provider (such as 183 Session Progress or 200 OK) into corresponding lightweight protocol messages, ensuring seamless session control between I1 and SIP protocols.

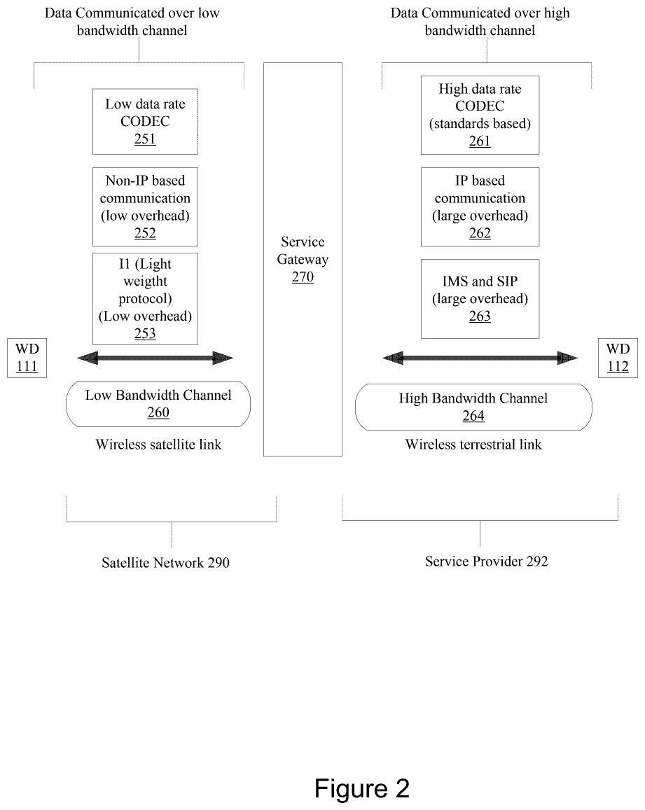

FIG. 2 shows a wireless device 111 wirelessly connected to a service gateway 270 through a low bandwidth channel 260, and a wireless device 112 connected to the service gateway 270 through a high bandwidth channel 264, according to an embodiment. For an embodiment, the low bandwidth channel 260 is a wireless satellite link and the high bandwidth channel 264 is a wireless terrestrial link.

FIG. 2 shows on a high level how the service gateway 270 provides a way to convert between two different networks and protocols. For an embodiment, the satellite network 290 uses the wireless satellite link to communicate with wireless devices. For an embodiment, the wireless satellite link on a low bandwidth channel 253. For an embodiment, in order to support data communication over such low-bandwidth channel, the satellite network 290 uses low data rate CODEC 251, non-IP based wireless communication. For an embodiment, because the overall system overheads are low, the satellite network 290 uses lightweight protocols like I1 which have low overhead 253. For an embodiment, the service provider 292 uses a wireless terrestrial link to communicate with terrestrial wireless devices through a high bandwidth channel 264. For an embodiment, the service provider 292 enables data communication over this high bandwidth channel using high data rate CODEC 261, IP based communication 262. Further, for an embodiment, the service provider 292 uses IMS and SIP for voice calling 263. For an embodiment, the service gateway 270 is the translator or converter between the satellite network 290 and the service provider 292 to enable the cross working of these different communication protocols and methodology. For an embodiment, the service provider 270 converts the low data rate CODEC 251 data into a format which is supported by the service provider 292 and vice versa. Similarly, for an embodiment, the service provider 270 converts non-IP based communication 252 coming from satellite network 290 to IP based communication for the service provider 292 and vice versa.

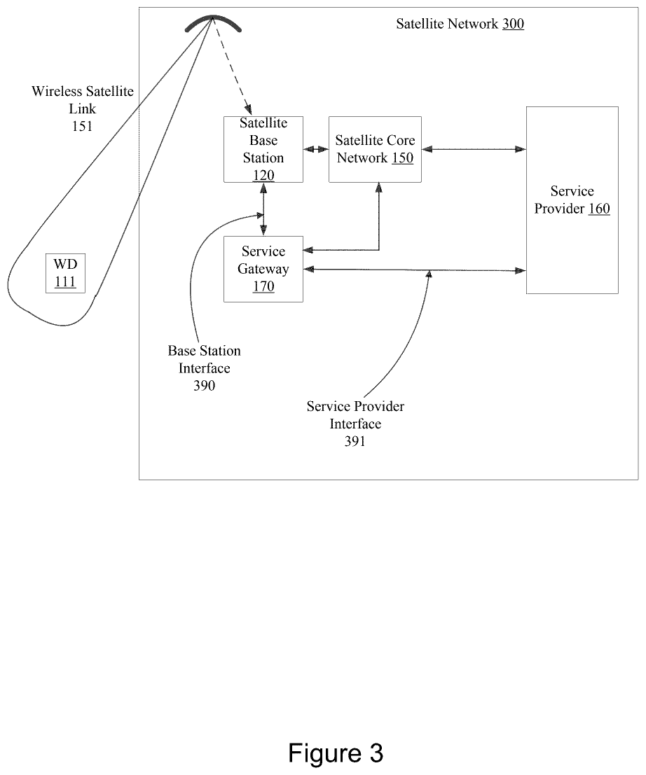

FIG. 3 shows a satellite network 300 that manages an interface between a wireless device and a service provider, according to another embodiment. As shown, the satellite network 300 further includes a base station interface 390 and a service provider interface 391.

For an embodiment, the service gateway 170 is further configured to form the base station interface 390 with the base station 120 through the base station interface 390. For an embodiment, the base station interface includes GTP (GPRS Tunnelling Protocol) tunnel between base station and service gateway.

For an embodiment, the service gateway 170 is further configured to form the service provider interface 391 with upper layers of the service provider 160. For an embodiment, the service gateway 170 is further configured to communicate with the upper layers of the service provider 160 through the service provider interface 391. For an embodiment, the upper layers of the service provider 160 may include IMS, SBC, or application layer components.

For an embodiment, the service gateway 170 is further configured to collect information about ongoing services associated with the wireless device 111 from both the base station interface 390 and the service provider interface 391. For an embodiment, the ongoing services include voice, streaming, OTT voice and other types of active services related to the wireless device 111.

For an embodiment, the service gateway 170 is further configured to communicate information obtained from the service provider interface 391, including upper-layer service information including call start and call stop events, and optionally codec information, to the base station through the base station interface 390. Further, for an embodiment, the base station is configured to adapt an air interface of the satellite network 300 for the wireless device 111 based on the information received from the service gateway 170, wherein the information pertains to the ongoing services associated with the wireless device 111. Further, for an embodiment, the base station 120 is configured to initiate and terminate based on information received from the service gateway 170 configurations including initiating semi-persistent scheduling mechanism, configuration of physical channels, allocation of resources on the physical channels, and other air interface adjustments for the wireless device. For an embodiment, for the voice call service, the base station can establish two NIDD (non-IP data delivery) over user plane bearers. One for voice control packets which (can be referred as voice control channel) and another for voice media packets (which can be referred as voice media channel). Depending upon the QoS and latency requirements, the base station can enable different features for different channels. For the voice control packet, the base station can enable RLC acknowledgements as reliability is more important. For the voice media channel, the base station can enable RLC UNAck (RLC Unacknowledge mode) and NO-HARQ feature. This helps in reducing latency and optimizing resources for the voice media channel. In addition to this, the base station can use data streaming features for a voice media channel. Data streaming feature enables multiple uplink and downlink packet transmission (PUSCH and PDSCH) and using a single grant.

For an embodiment, the service gateway 170 is further configured to utilize information received from the base station to trigger upper-layer modifications in response to changes in the satellite network interface, and communicate the upper-layer modifications to the service provider, wherein the upper-layer modifications includes service adjustments including stopping a service if the base station informs the service gateway of a radio-link failure experienced by the wireless device. For an embodiment, if a link quality doesn't meet the minimum service acceptance criteria for more than a threshold duration of time, then the call can be stopped by the service gateway. For an embodiment, the service acceptance criteria include signal quality, block error rate, MCS and repetition used for data transmission.

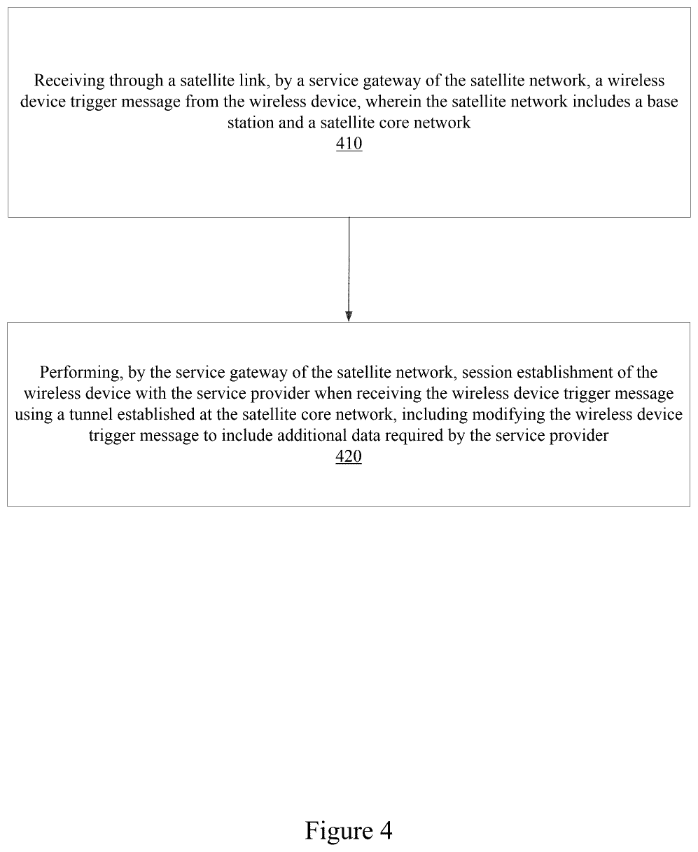

FIG. 4 is a flow chart that includes steps of a method for a satellite network managing an interface between a wireless device and a service provider according to an embodiment. A first step 410 includes receiving through a satellite link, by a service gateway of the satellite network, a wireless device trigger message from the wireless device, wherein the satellite network includes a base station and a satellite core network. A second step 420 includes performing, by the service gateway of the satellite network, session establishment of the wireless device with the service provider when receiving the wireless device trigger message, including modifying the wireless device trigger message to include additional data required by the service provider.

As described, for an embodiment, the wireless device trigger message does not include at least some mandatory data required by the service provider for session establishment with the service provider, and wherein the service gateway of the satellite network supplements the wireless device trigger message with the mandatory data.

For an embodiment, receiving through the satellite link the wireless device trigger message from the wireless device includes a voice manager of the service gateway receiving a lightweight protocol INVITE message transmitted from the wireless device. For an embodiment, the satellite link is facilitated by the base station (gNodeB-5G or eNodeB-4G), wherein the base station is configured to interface with the wireless device, and the base station and the voice manager are two components of satellite communication network.

For an embodiment, performing the session establishment of the wireless device with the service provider when receiving the wireless device trigger message includes translating, by the voice manager, the lightweight protocol INVITE message into a (an IMS or Non-IMS) Session Initiation Protocol (SIP) INVITE message, wherein the voice manager is implemented within the satellite core network to enable compatibility with the service provider, and the voice manager further implements a translation between lightweight protocol and 3GPP-defined CS-Voice/IMS-SIP protocols to enable compatibility with the service provider.

At least some embodiments further include establishing, by the voice manager, SIP or SS7 registration for the wireless device with a 3GPP IMS core network or SS7 network, wherein the registration involves communication with network components, including a Home Subscriber Server (HSS), Proxy Call Session Control Function (P-CSCF), or Home Location Register (HLR). At least some embodiments further include maintaining, by the voice manager, session continuity by exchanging periodic signaling messages between the wireless device and the service provider.

For an embodiment, managing the interface of the satellite network between the wireless device and the service provider comprises interworking between the lightweight protocol and SIP protocols in NB-IoT networks includes interfacing, by the voice manager, with 3GPP network components (including for example, Access and Mobility Management Function (AMF), Session Management Function (SMF), User Plane Function (UPF), Mobility Management Entity (MME), and Packet Gateway (PGW)) for session establishment and data flow management, translating, by the voice manager, lightweight protocol messages into SIP-compliant messages, wherein the translation includes mapping media parameters via Session Description Protocol (SDP) for codec (compression, decompression) negotiation and session setup, and performing, by the voice manager, codec translation, wherein lightweight codecs optimized for NB-IoT are converted into standard Real-Time Protocol (RTP) codecs compatible with terrestrial IMS core networks. At least some embodiments further include exchanging, by the voice manager, media parameters during session negotiation using SDP, ensuring compatibility between low-bandwidth NB-IoT codecs and terrestrial IMS codecs, and handling, by the voice manager, low-bandwidth constraints of the satellite network by optimizing message sizes and reducing protocol overhead between the wireless device and the satellite network. At least some embodiments further include relaying, by the base station, lightweight protocol messages from wireless devices to the voice manager over satellite links, wherein the base station manages an air interface for wireless communication, synchronizing, by the base station, session management operations between the voice manager and IMS core networks, ensuring seamless end-to-end communication, and performing, by the base station, adaptive scheduling of resources on the air interface to prioritize voice traffic based on Quality of Service (QoS) requirements.

For an embodiment, managing session initiation includes initiating, by the satellite network, a voice call through transmission of an SIP INVITE/SS7 message for the wireless device connected through satellite network, and translating, by the voice manager, the SIP INVITE message into a SS7 INVITE message, wherein the translated message is transmitted to the wireless device over the satellite link.

At least some embodiments further include negotiating, by the voice manager, codecs for media transmission during session setup using SDP parameters, wherein, the negotiation ensures compatibility between lightweight NB-IoT codecs and codecs supported by the service provider, and encapsulating, by the voice manager, media data encoded with low-bandwidth NB-IoT codecs into voice streams for delivery to the service provider. At least some embodiments further include terminating, by the voice manager, a session upon receiving a SIP BYE message from a voice network or an IMS core network, and translating, by the voice manager, the SIP BYE message into a lightweight protocol BYE message for transmission to the wireless device, ensuring session termination consistency. For an embodiment, the voice manager maintains a database for the wireless device which includes the device identifier used by lightweight protocol, assigned IP address for the wireless device and the device identifier used by the service provider for the wireless device. After receiving the SIP BYE, the voice manager of the service gateway uses the data accessed from the database to translate the SIP BYE to the lightweight protocol BYE message. For an embodiment, the voice manager also maintains the state and context of the service session—which may include time of the message received, sequence number, expiration time, whether an ack is expected for the SIP Bye message. After sending the lightweight protocol message, voice manager may wait for a response from the wireless device and retransmit the lightweight protocol BYE message to the wireless device. If the service provider expects a response for the SIP BYE message, then voice manager can generate the response on behalf of the wireless device and send it to the service provider. For an embodiment, the voice manager need not wait for a response from the wireless device in order to send a response to the service provider. For an embodiment, the voice manager can maintain both communications asynchronously. For an embodiment, the database maintains the context for both communications (communication between the voice manager and the service provider and communication between the voice manager and the wireless device. It is to be understood that this process can also be applied to other message exchanges and translations.

At least some embodiments further include maintaining asynchronous communication between the voice manager and the service provider and voice manager and wireless device, thereby ensuring seamless interoperability between the satellite network and a terrestrial voice network or IMS core networks by maintaining compatibility across protocol layers. For an embodiment voice manager can generate messages on behalf of the wireless device and send the messages to the service provider and vice versa.

At least some embodiments further include supporting, by the voice manager, low-bandwidth codecs optimized for NB-IoT, and translating, by the voice manager, low-bandwidth codecs into standard codecs used in RTP streams for SIP-based communication networks. For an embodiment, the voice manager generates a sequency number for the lightweight-protocol voice packets based on the timestamp at which a packet is received by the base station. This timestamp and the generated sequence number are stored as session context in the database. For an embodiment, the voice manager uses this information to create a RTP (standard defined real time protocol commonly used for voice applications) header for the voice packet while sending it to the service provider. For an embodiment, the voice manager also translates the voice packet from low-bandwidth codec used by the lightweight protocol to the standard codec negotiated between voice manager and service provider using SDP protocol (session description protocol).

At least some embodiments further include registering, by the voice manager, wireless devices with IMS core components, including HSS and P-CSCF, during session initiation, managing, by the voice manager, session updates and terminations using SIP signaling, and registering, by the voice manager, wireless devices with SS7 components, including HLR and MSC (Mobile Switching Center)/SBC (Session Border Controller), during session initiation. For an embodiment, the MSC is an element of the core network that serves as a control center within the Network Switching Subsystem (NSS). For an embodiment, the MSC is responsible for managing call setup, routing, and termination, as well as handling subscriber data and mobility management. For an embodiment, the SBC is a network element deployed to protect SIP based voice over Internet Protocol (VoIP) networks. For an embodiment, the voice manager is responsible for registering the wireless device with the service provider. If the voice manager receives a lightweight trigger message from the wireless device and the wireless device is not already registered with the service provider, then the voice manager initiates registration process with the service provider. For an embodiment, registration with the service provider includes registration with IMS core components, including HSS and P-CSCF. For an embodiment, the voice manager also registers wireless devices with SS7 components including HLR and MSC/SBC, during session initiation. For an embodiment, the voice manager receives and generates SIP signaling messages on behalf of the wireless device for the registration process.

At least some embodiments further include reducing, by the voice manager, signaling overhead by leveraging lightweight protocol messages for session initiation and maintenance, eliminating, by the voice manager, redundant IP stack elements within the voice manager while sending the messages to the wireless device using lightweight protocol, and maintaining, by the voice manager, Quality of Service (QoS) by prioritizing voice traffic over data traffic during transmission over satellite links.

For an embodiment, the wireless device trigger message is transmitted by the wireless device using a non-IP data transport layer, and wherein the mandatory data added by service gateway includes at least one of a TCP (Transmission Control Protocol) IP (internet protocol), a UDP (User Datagram Protocol) IP, or a SCTP (Stream Control Transmission Protocol) IP.

At least some embodiments further include converting, by the service gateway, the wireless device trigger message received from the wireless device into a 3GPP (specifically SS7 or SIP multimedia message) defined message, and forwarding the 3GPP defined message to the service provider after the registration is completed.

At least some embodiments further include receiving through the satellite link, by the service gateway, wireless device communication messages from the wireless device, converting, by the service gateway, the wireless device communication messages received from the wireless device into a 3GPP (specifically SS7 or SIP multimedia message) defined messages, and forwarding the 3GPP defined messages to the mobile carrier network after the registration is completed.

For an embodiment, the wireless device trigger message causes a voice call over an NB-IOT network to be initiated, and further comprising converting, by the service gateway, a mobile network trigger message received from the wireless device into a 3GPP defined (SIP protocol) voice trigger equivalent message. For an embodiment, the wireless device communicates messages using a lightweight voice codec for voice packets, wherein service gateway converts the wireless device communication message received from the wireless device into voice packets using standard voice codecs supported by the service provider.

At least some embodiments further include receiving, by the service gateway of a satellite, a mobile network trigger message from the service provider, converting, by the service gateway, the mobile network trigger message received from the wireless device into a lightweight protocol equivalent message, and forwarding the lightweight protocol equivalent message to the wireless device. For an embodiment, the lightweight protocol uses a non-IP data path. For an embodiment, converting the mobile network trigger message received from the service provider into the lightweight protocol equivalent message eliminates at least an IP stack and other mandatory data required by terrestrial mobile networks to enable voice and multimedia communication.

For an embodiment, the wireless device trigger message is defined by a lightweight protocol between the wireless device and the service gateway, and functions of the service gateway include interworking between the lightweight protocol and a 3GPP SIP protocol, wherein interworking includes mapping between the lightweight protocol messages and standard SIP messages. For an embodiment, interworking includes the mapping between the lightweight messages and standard SIP messages. For an embodiment, interworking also includes the steps taken by the voice manager after receiving a message either by service provider or wireless device. For example, if the voice manager receives a Msg A (of SIP protocol) from service provider, then service provider should send back a Msg B of SIP protocol to the service provider and send Msg M of lightweight protocol to the wireless device. This may also include the retransmission policy for both Msg B and Msg M and also whether a response is required for the message along with the expiration policy. For this example, Msg A and Msg B are messages defined in SIP protocol and Msg M is a message of lightweight protocol. For an embodiment, the lightweight protocol includes several messages for different purposes. For example, a lightweight trigger message is a message of the lightweight protocol used to trigger a service session.

For an embodiment, the wireless device trigger message triggers a voice call, wherein the wireless device trigger message includes a session description protocol offer for negotiation, and the service gateway responds with a session description protocol answer.

At least some embodiments further include converting, by the service gateway, SIP (session initiator protocol) responses received from the service provider (such as 183 Session Progress or 200 OK) into corresponding lightweight protocol messages, ensuring seamless session control between I1 and SIP protocols.

At least some embodiments further include communicating, by the service gateway, with the base station through a base station interface, wherein base station provides a receive timestamp of voice packets to the service gateway using a base station interface, wherein the base station interface is a communication interface between service gateway and base station. At least some embodiments further include forming, by the service gateway, a service provider interface with upper layers of the service provider, and communicating, by the service gateway, with the upper layers of the service provider through the service provider interface. For an embodiment, forming between the service gateway of the satellite network, an interface with the upper layers of the service provider, referred to as the service provider interface, wherein the upper layers may include NAS, IMS, I1, or application layer components; and communicating, by the service gateway, with the upper layers of the service provider through the service provider interface.

At least some embodiments further include collecting, by the service gateway, information about ongoing services associated with the wireless device from both the base station interface and the service provider interface, wherein the ongoing services include voice, streaming and other types of active services related to the wireless device. For an embodiment, collecting, by a service gateway of the satellite network, information about ongoing services associated with the wireless device from both the base station interface and the service provider interface, wherein the ongoing services include voice, streaming and other types of active services related to the wireless device. At least some embodiments further include communicating, by the service gateway, information obtained from the service provider interface, including upper-layer service information including call start and call stop events, to the base station through the base station interface, adapting, by the base station, an air interface of the satellite network for the wireless device based on the information received from the service gateway, wherein the information pertains to the ongoing services associated with the wireless device, and initiating and terminating, by the base station, based on information received from the service gateway, configurations including one or more of initiating semi-persistent scheduling mechanism, configuration of physical channels, allocation of resources on the physical channels, and other air interface adjustments for the wireless device.

At least some embodiments further include utilizing, by the service gateway, information received from the base station to trigger upper-layer modifications in response to changes in a satellite network interface, and communicating, by the service gateway, the upper-layer modifications to the service provider, wherein the upper-layer modifications includes service adjustments including stopping a service if the base station informs the service gateway of a radio-link failure experienced by the wireless device.

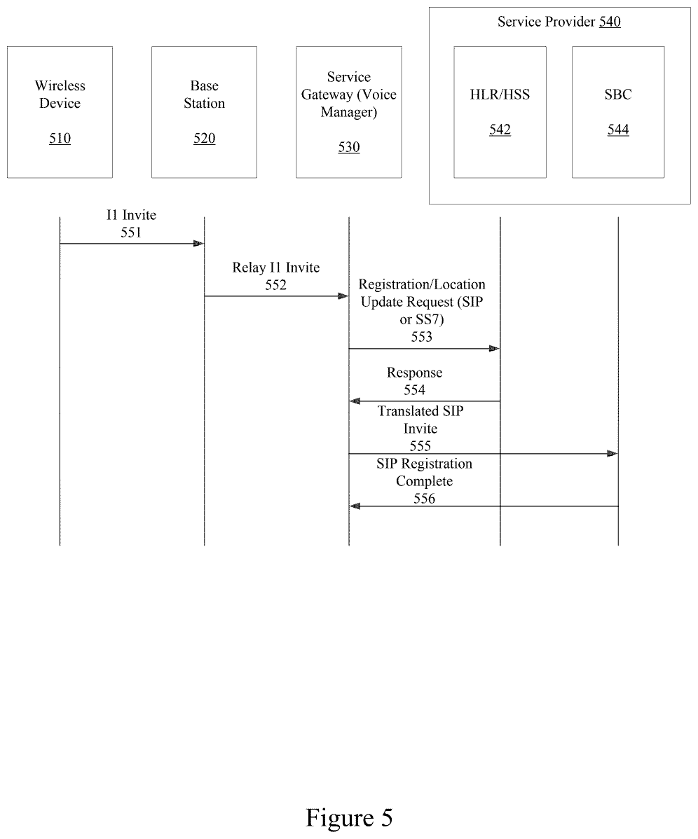

FIG. 5 shows a timeline of establishing, by the voice manager, SIP or SS7 registration for the wireless device with a 3GPP IMS core network or SS7 network, according to an embodiment. For an embodiment, the registration involves communication with network components, including a Home Subscriber Server (HSS), Proxy Call Session Control Function (P-CSCF), or Home Location Register (HLR). As shown, a base station 520 receives, for example, an I1 invite 551 from the wireless device 510. The base station 520 relays the I1 invite 552 to the voice manager of the service gateway 530. The voice manager of the service gateway 530 then sends a registration/location update request (SIP or SS7) to an HLR/HSS of the service provider 540. The HLR/HSS of the service provider 540 responds 554 wherein the response is received by the voice manager of the service gateway 530. The voice manager of the service gateway 530 then sends a translated SIP invite 555 to an SBC (session border controller) 544 of the service provider 540. The SBC 544 of the service provider 540 then sends an SIP registration complete 556 back to the voice manager of the service gateway 530.

For an embodiment, the voice manager of the service gateway 530 operates to register the wireless device 510 with the service provider 540 using a 3GPP standard defined SIP or SS7 registration process. SS7 is a set of telephony signaling protocols that are used to set up most of the world's public switched telephone network (PSTN) telephone calls.

For an embodiment, the 3GPP IMS core network includes a modern, IP-based system designed to deliver multimedia services like voice, video, and messaging over packet networks, while an SS7 network is a legacy signaling system used for traditional circuit-switched phone calls, primarily supporting basic call setup and routing functions on older mobile networks; essentially, IMS is a newer, more flexible technology built for IP-based communication, while SS7 is an older system used for traditional circuit-switched networks. For an embodiment, the voice manager of the service gateway 530 is connectable to either of the 3GPP IMS core network or the SS7 network.

For an embodiment, the Home Subscriber Server (HSS) is defined by the standards as the master repository that contains subscriber and device profile and state information. The HSS supports authentication, authorization and mobility management functions, and the HSS supports standards-based interfaces LTE MME (S6a).

For an embodiment, the P-CSCF (proxy call session control function) plays a SIP proxy role in session control. For an embodiment, the P-CSCF is the first point of access into the IMS core network for a wireless device request. For an embodiment, in normal processing the P-CSCF forwards the requests made on behalf of the wireless device without modifying the Request-URI. For an embodiment, only under abnormal cases can the P-CSCF originate or terminate a SIP request.

For an embodiment, the Home Location Register (HLR) is a database that stores information about mobile network subscribers. For an embodiment, the HLR contains details like phone numbers, services, and locations.

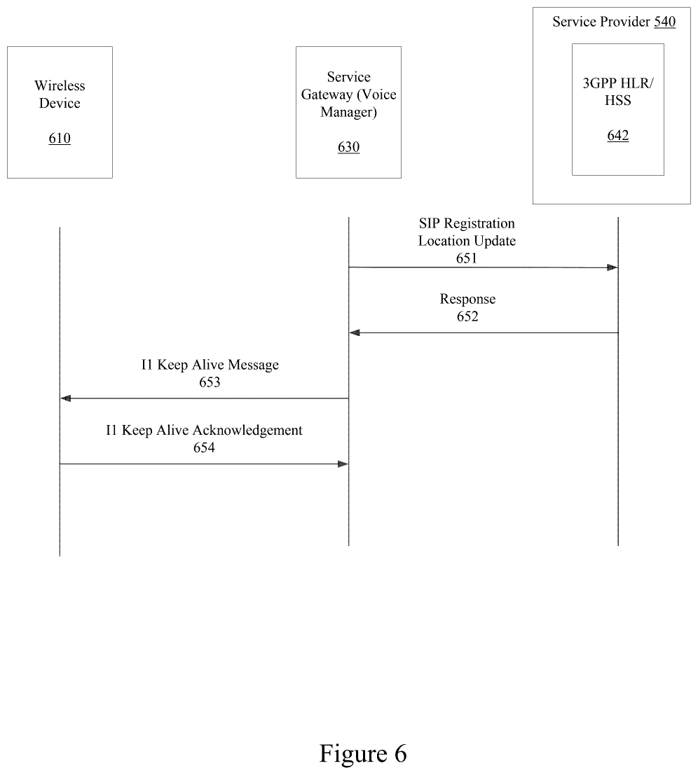

FIG. 6 shows a timeline of maintaining, by a voice manager of a service gateway 630, session continuity by exchanging periodic signaling messages between a wireless device 610 and the service provider 540, according to an embodiment. For an embodiment, signaling messages include SIP keep-alive messages, such as SIP OPTIONS, for IMS core networks, or lightweight protocol messages for NB-IoT devices, thereby enabling uninterrupted communication between the wireless device 610 and the service provider 540. For an embodiment the signaling allows for the session continuity to be maintained because the service provider can drop the connection if keep-alive message is not received in a threshold time duration. Therefore, the voice manager of the service gateway 630 generates signaling messages at regular time intervals to ensure that service provider 540 maintains the connection.

As shown, the 3GPP IMS core network 642 of the service provider 540 receives an SIP registration/location update 651 from the voice manager of the service gateway 630. The 3GPP IMS core network 642 of the service provider 540 then responds 652. The voice manager of the service gateway 630 then sends an I1 keep alive message 653 to the wireless device 610. The wireless device 610 then responds with an I1 keep alive message acknowledgement 654.

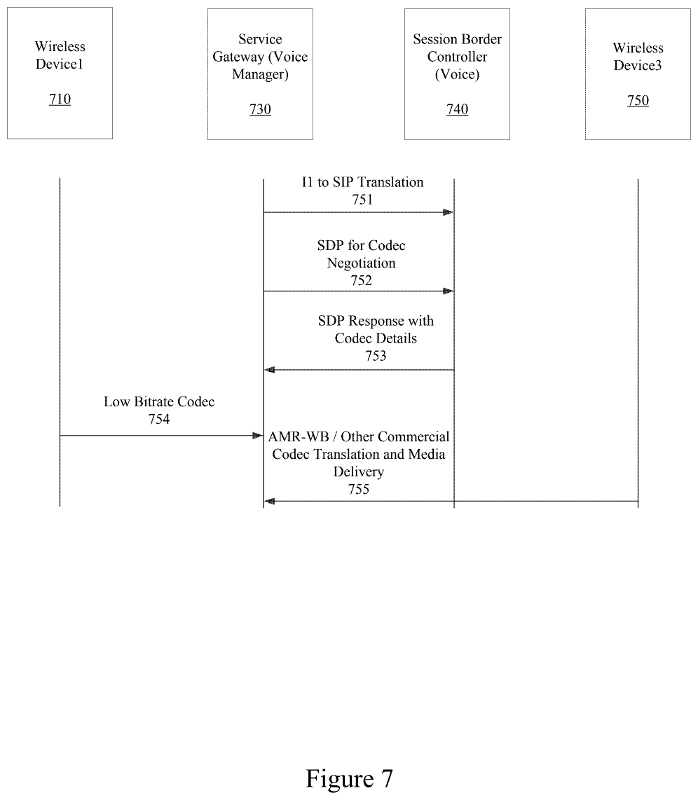

FIG. 7 shows a timeline of managing the interface of the satellite network between the wireless device and the service provider, and the codec transcoding by the voice manager according to an embodiment. For an embodiment, managing the interface of the satellite network between the wireless device and the service provider comprises interworking between the lightweight protocol and SIP protocols in NB-IoT networks, including interfacing, by the voice manager, with 3GPP network components (including, for example, Access and Mobility Management Function (AMF), Session Management Function (SMF), User Plane Function (UPF), Mobility Management Entity (MME), and Packet Gateway (PGW)) for session establishment and data flow management, translating, by the voice manager, lightweight protocol messages into SIP-compliant messages, wherein the translation includes mapping media parameters via Session Description Protocol (SDP) for codec (compression, decompression) negotiation and session setup, and performing, by the voice manager, codec translation, wherein lightweight codecs optimized for NB-IoT (e.g., 1-3 kbps codecs) are converted into standard Real-Time Protocol (RTP) codecs compatible with terrestrial IMS core networks. For an embodiment, the interface is implemented using an IP tunnel between satellite network components and service provider components.

For an embodiment, the voice manager of the service gateway 170 is responsible for registering the wireless device 111 with the service provider 160. If voice manager receives a lightweight trigger message from the wireless device 111 and wireless device 111 is not already registered with the service provider 160, then voice manager 160 initiates the registration process with the service provider 160.

After the registration process is done, the voice manager starts the service initiation process with the service provider. Voice manager creates or translates a SIP invite message, based on the information received in the lightweight protocol trigger message and wireless device information stored in the voice manager database and sends it to the service provider. The wireless device information stored in the voice manager database includes the wireless device context saved during registration, APNs and service capability associated with the wireless device, IP address and other identifiers associated with the wireless device including IMSI.

For an embodiment, the session establishment includes transmission of signaling messages which can be used for initiating and terminating the voice call, signaling messages to keep the connection alive, signaling messages to negotiate the voice codec and quality of service. For an embodiment, data flow management includes translation and transmission of actual voice media packets. For an embodiment, the Session Description Protocol (SDP) is used to negotiate codec, quality of service requirements for the voice call between service gateway and service provider. For an embodiment, the lightweight codecs optimized for NB-IoT and can include an ML (machine learning) based codec with 0.5 to 3 kbps code rate.

As shown, for an embodiment, the voice manager of the service gateway 730 communicates I1 to SIP translation 751 to a session border controller (voice) 740, and SDP for codec negotiation 752 to the session border controller (voice) 740. The session border controller (voice) 740 communicates SDP response with codec details 753 to the voice manager of the service gateway 730. The voice manager of the service gateway 730 then establishes/communicates low bitrate codec 754 to the wireless device1 710. The voice manager of the service gateway 730 then establishes and communicates AMR-WB commercial translation and media delivery 755 to another wireless device3.

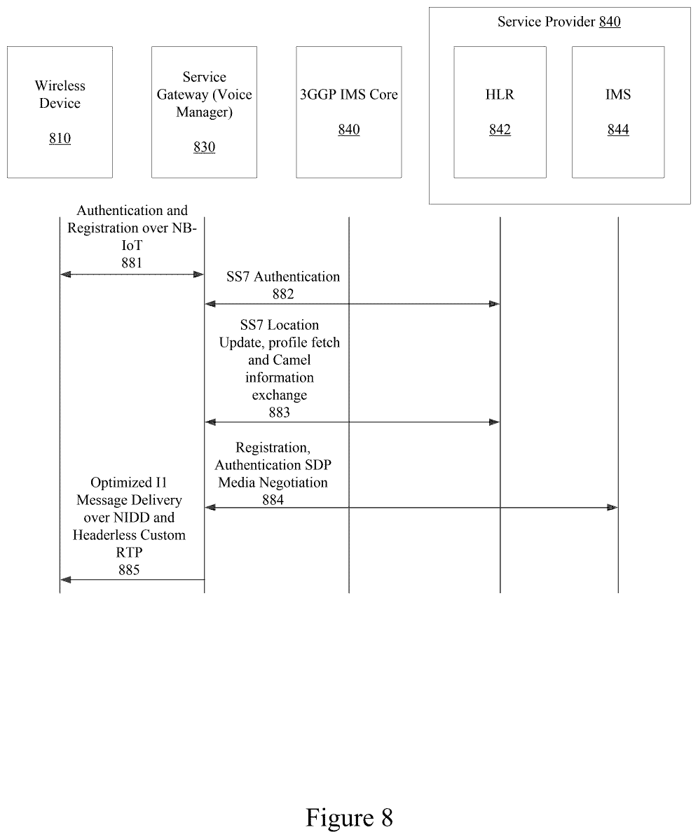

FIG. 8 shows a timeline of exchanging, by a voice manager of a service gateway 830, media parameters during session negotiation using SDP, ensuring compatibility between low-bandwidth NB-IoT codecs and terrestrial IMS codecs, according to an embodiment. Further, the voice manager of the service gateway 830 is configured to handle low-bandwidth constraints of the satellite network by optimizing message sizes and reducing protocol overhead between the wireless device 810 and the service gateway 830 of the satellite network. For an embodiment, the low-bandwidth constraints are handled by reducing protocol overhead and reducing message size of lightweight protocol used between wireless device 810 and the service gateway 830 of the satellite network.

As shown, authentication and registration over an NB-IoT network 881 is performed between the wireless device 810 and the voice manager of the service gateway 830. Further, SS7 authentication 882 is performed between the voice manager of the service gateway 830 and the HLR 842 of the service provider 840. Further, an SS7 location update, profile fetch and camel information exchange 883 is performed between the HLR 842 of the service provider 840 and the voice manager of the service gateway 830. Further, a registration, authentication SDP media negotiation 884 is performed between the voice manager of the service gateway 830 and the IMS 844 of the service provider 840. Finally, the voice manager of the service gateway 830 communicates and optimized I1 message delivery over NIDD and header less custom RTP 885 to the wireless device 810.

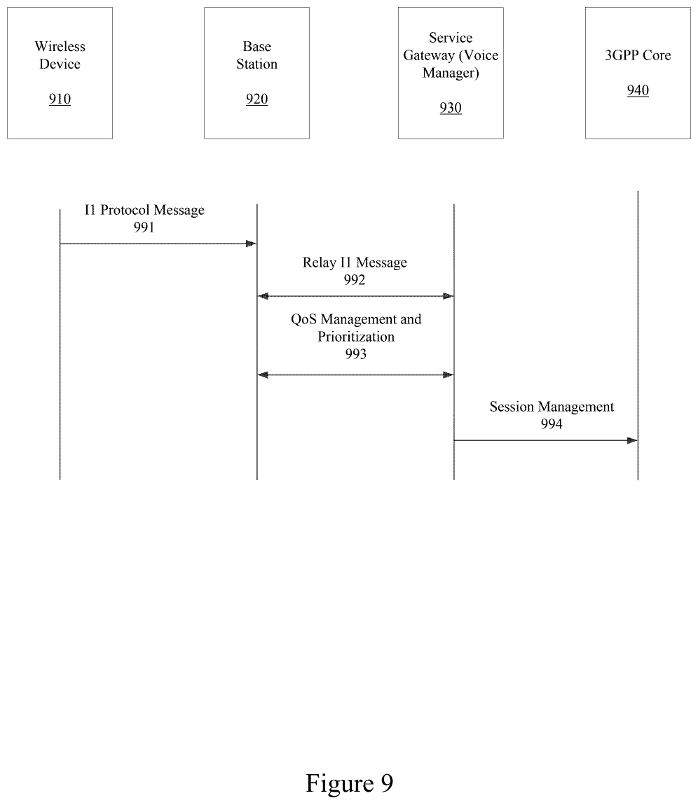

FIG. 9 shows a timeline of synchronization, by the base station 920, session QoS (quality of service) management operations between the voice manager of the service gateway 930 and the wireless device 910, ensuring seamless end-to-end communication, according to an embodiment. For this embodiment, the base station 920 relays lightweight protocol messages from the wireless device 910 to the voice manager of the service gateway 930 over satellite links, wherein the base station 920 manages an air interface for wireless communication. Further, the base station 920 performs adaptive scheduling of resources on the air interface to prioritize voice traffic based on Quality of Service (QoS) requirements. That is, for an embodiment, the base station 920 assigns time and subcarrier slots to meet the quality-of-service requirements of the satellite.

As shown, the wireless device 910 communicates an I1 protocol message 991 to the base station 920, which then relays the I1 message 992 to the voice manager of the service gateway 930. QoS management and prioritization 993 is established between the voice manager of the service gateway 930 and the base station 920 and is established between the base station and wireless device. The voice manager of the service gateway 930 sends a session management 994 to the 3GPP core 940.

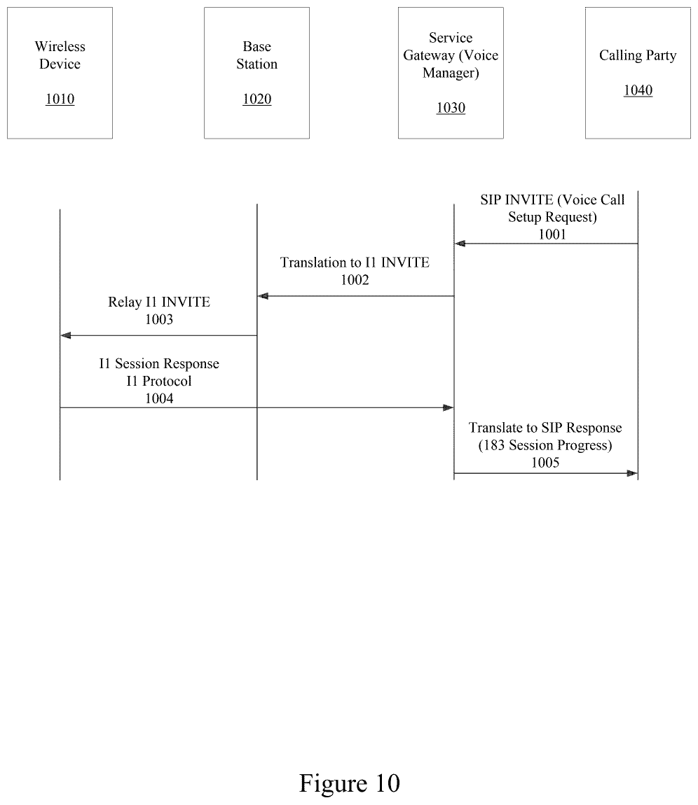

FIG. 10 shows a message flow for a voice call terminated by the wireless device, according to an embodiment. For an embodiment, the calling party initiates a voice call through transmission of an SIP INVITE for the wireless device connected through the satellite network. Further, for an embodiment, the voice manager of the service gateway 1030 translates the SIP INVITE message into an I1 INVITE message, wherein the translated message is transmitted to the wireless device over the satellite link. For an embodiment, I1 is an implementation of the lightweight protocol. The calling party may be the service provider or another device (for example, another wireless device) connected to the service provider.

As shown, a calling party 1040 sends an SIP INVITE (voice call setup request) 1001 to the voice manager of the service gateway 1030. The voice manager of the service gateway 1030 translates the SIP INVITE to I1 INVITE and transmits the I1 INVITE 1002 to the base station 1020. The base station 1020 then sends a relay I1 invite to the wireless device 1010. The wireless device then communicates an I1 session response I1 protocol 1004 to the voice manager of the service gateway 1030. The voice manager of the service gateway 1030 then transmits a translated SIP response (183 session progress) 1005 to the calling party.

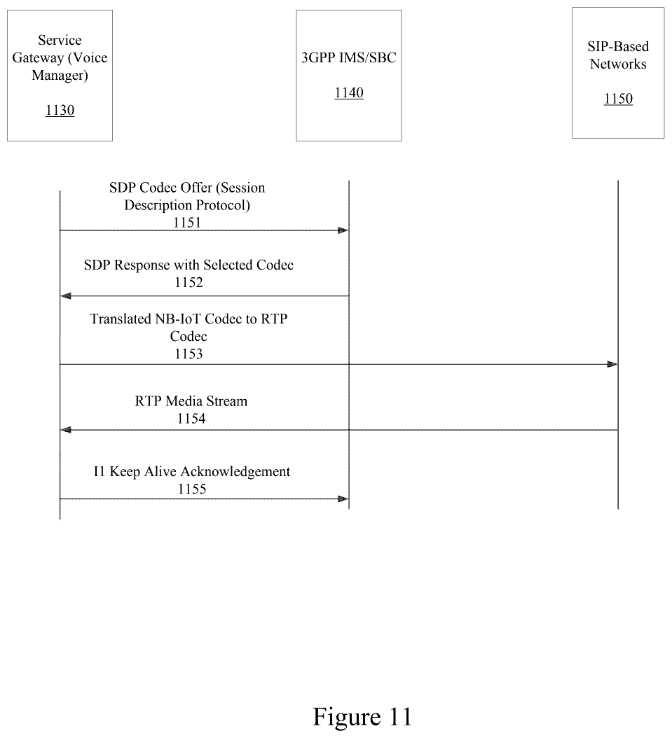

FIG. 11 shows a timeline of negotiating codecs for media transmission during session setup, according to an embodiment. For an embodiment, the voice manager of the service gateway 1130 is configured to negotiate codecs for media transmission during session setup using SDP parameters, wherein, the negotiation ensures compatibility between lightweight NB-IoT codecs and codecs supported by the service provider. During negotiation, the voice manager identifies a common codec which is supported by the service provider and for which voice manager supports the transcoding with the lightweight codec. The service provider need not to support the light-weight codec itself. The negotiation process ensures that the voice manager can transcode the lightweight protocol in a standard codec which is supported by the service provider. Further, the voice manager of the service gateway 1130 is configured to encapsulate media data encoded with low-bandwidth NB-IoT codecs into voice streams using negotiated codec for delivery to the service provider. For an embodiment, codec negotiations occur using SDP payload in SIP protocol as per the 3GPP standard. As part of the protocol the voice manager of the service gateway 1130 provides the list of codecs supported by voice manager and service provider reciprocates with the codecs supported by device. The voice manager identifies the codec supported from the list by both voice manager and service provider and uses the identified codec for a voice stream.

As shown, the voice manager of the service gateway 1130 communicates an SDP (Session Description Protocol) message and offers a codec (compression, decompression standard) 1151 to a 3GPP IMS/SBC 1140. The 3GPP IMS/SBC 1140 then communicates an SDP response with selected codec 1152 back to the voice manager of the service gateway 1130. The voice manager of the service gateway 1130 then communicates with SIP based Networks 1150, by translating NB-IoT codec to negotiated codec 1153. The SIP-based networks 1150 then communicates an RTP media stream 1154 to the voice manager of the service gateway 1130. The voice manager of the service gateway 1130 then communicates I1 keep alive acknowledgements 1155 to the 3GPP IMS/SBC 1140 when required to maintain the SIP session between voice manager and service provider. For an embodiment, the service provider uses SIP protocol for voice signaling and RTP protocol for voice media packet transmission between service provider and voice manager, whereas the voice manager uses light-weight protocols between wireless device and voice manager. For an embodiment, the lightweight protocols are less than 3 kbps rate codecs which can be used over an NB-IOT network.

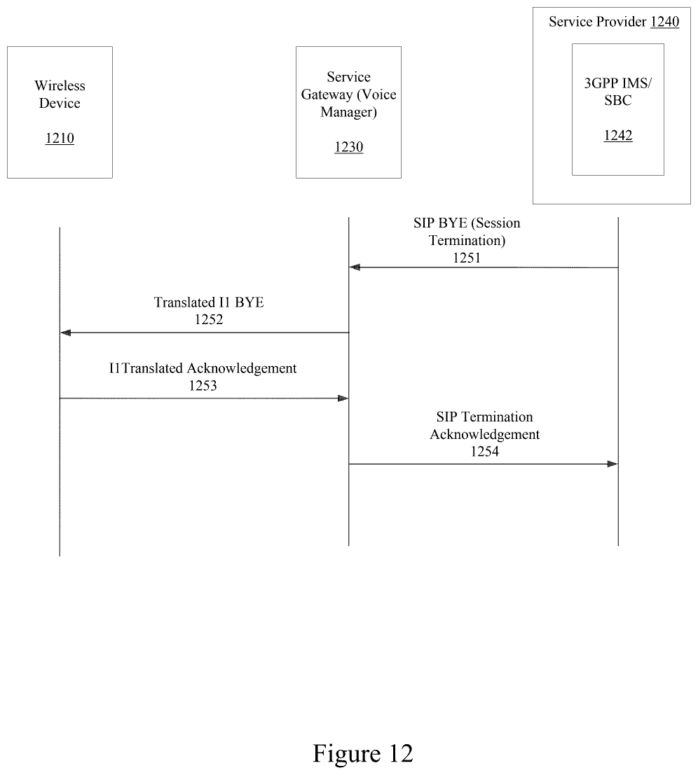

FIG. 12 shows a timeline of termination of a session between the wireless device and the service provider, according to an embodiment. For an embodiment, the voice manager of the service gateway 1130 terminates a session upon receiving a SIP BYE message (session termination) from a voice network or an IMS core network. Further, for an embodiment, the voice manager of the service gateway 1130 translates the SIP BYE message into a lightweight protocol BYE message for transmission to the wireless device, ensuring session termination consistency.

For an embodiment, the voice manager maintains a database for wireless device which includes the device identifier used by light weight protocol, assigned IP address for the wireless device and the device identifier used by the service provider for the wireless device. After receiving the SIP BYE, the voice manager of the service gateway uses the data accessed from the database to translate the SIP BYE to the lightweight protocol BYE message. The voice manager also maintains the state and context of the service session-which may include time of the msg received, sequence number, expiration time, whether an ack is expected for the SIP Bye msg. After sending the lightweight protocol message, the voice manager may wait for a response from the wireless device and retransmit the light-weight protocol BYE message to the wireless device. If the service provider expects a response for the SIP BYE message, then voice manager can generate the response on behalf of the wireless device and send it to the service provider. The voice manager need not wait to receive a response from wireless device in order to send a response to the service provider. The voice managers can maintain both communications asynchronously. For an embodiment, the database maintains the context for both the communication between voice manager and service provider and the communication between voice manager and wireless device. It is to be understood that the same is true for other message exchanges and translations.

As shown, a 3GPP IMS/SBC 1242 of a service provider 1240 communicates an SIP BYE (session termination) 1251 to the voice manager of the service gateway 1230. The voice manager of the service gateway 1230 communicates a translated I1 BYE to the wireless device 1210. The wireless device 1210 then communicates an I1 translate acknowledgement 1253 to the voice manager of the service gateway 1230. The voice manager of the service gateway 1230 communicates an SIP termination acknowledgment 1254 to the 3GPP IMS/SBC 1242 of the service provider 1240.

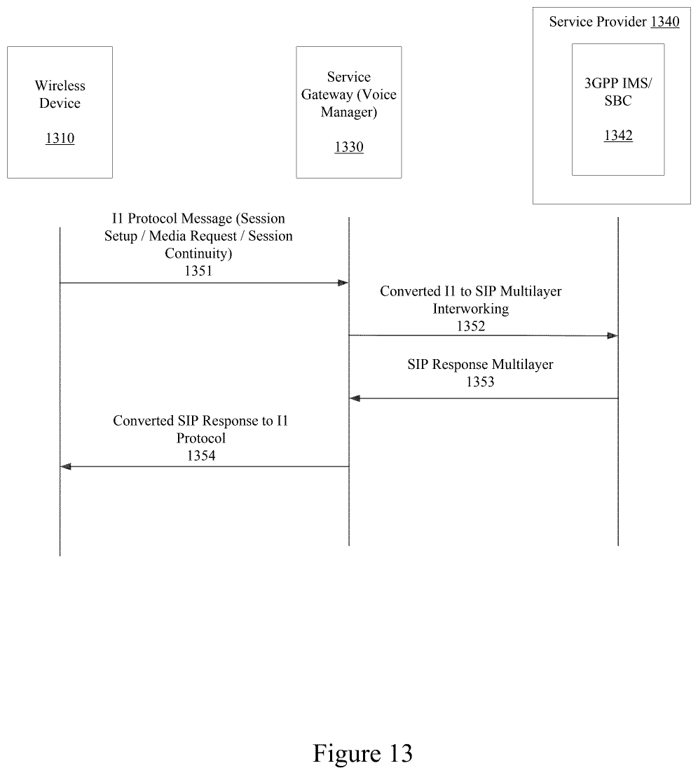

FIG. 13 shows a timeline of translating lightweight protocol messages into SIP-compliant messages and vice versa, according to an embodiment. For an embodiment, a protocol conversion module of the voice manager of the service gateway 1330 translates lightweight protocol messages into SIP-compliant messages and vice versa. For an embodiment, the translating ensures seamless interoperability between the satellite network and a terrestrial voice network or IMS core networks by maintaining compatibility across protocol layers.

As shown, for an embodiment, the wireless device 1310 communicates an I1 protocol message (session setup/media request/session continuity) 1351 to the voice manager of the service gateway 1330. The voice manager of the service gateway 1330 then communicates a convert I1 to SIP multilayer interworking 1353 to the 3GPP IMS/SBC 1342 of the service provider 1340. The 3GPP IMS/SBC 1342 of the service provider 1340 then communicates an SIP response multilayer 1353 back to the voice manager of the service gateway 1330. The voice manager of the service gateway 1330 communicates a converted SIP response I1 protocol to the wireless device 1310. For an embodiment, interworking includes the mapping between the lightweight messages and standard SIP messages. For an embodiment, interworking also includes the steps taken by the voice manager after receiving a message either by service provider or wireless device.

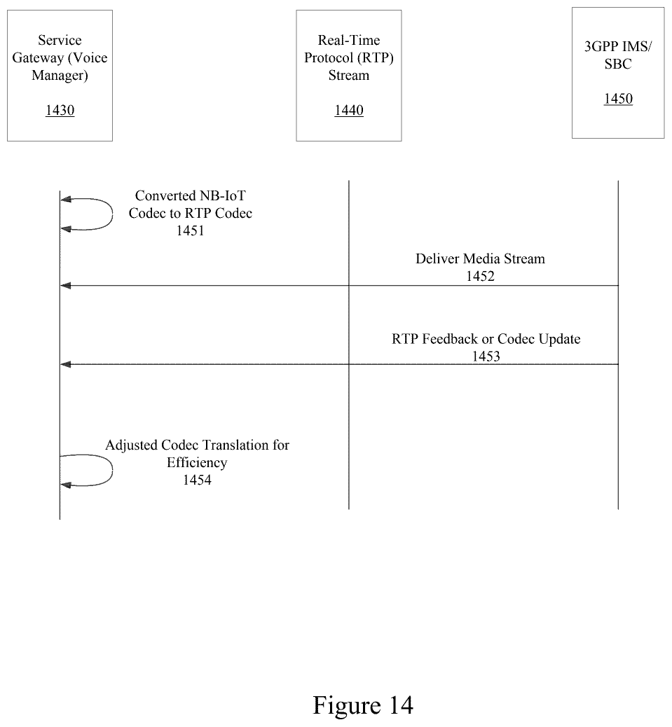

FIG. 14 shows a timeline of translating, by the voice manager, low-bandwidth codecs into standard codecs, according to an embodiment. For an embodiment, the voice manager of the service gateway 1430 supports low-bandwidth codecs optimized for NB-IoT which includes real-time encoding, decoding of the voice packets and transcoding voice packets between light-weight packets and at least one standard based codec supported by service provider. Further, the voice manager of the service gateway 1430 is configured to translate voice packets coded using low-bandwidth codecs into voice packets coded using standard codecs used in RTP streams for SIP-based communication networks.

As shown, the voice manager of the service gateway 1430 converts from voice packets encoded using NB-IoT codec to voice packets encoded using RTP codec 1451. Next, the voice manager of the service gateway 1430 sends a delivery media stream 1452 (by adding RTP header to the voice stream encoded using standard codec) to the 3GPP IMS/SBC 1450 of the service provider. Then the 3GPP IMS/SBC 1450 of the service provider sends an RTP feedback or codec update if an update is required in the codec used for voice packet encoding 1453. Finally, the voice manager of the service gateway 1430 operates to adjust codec translation as requested by the IMS/SBC for efficiency.

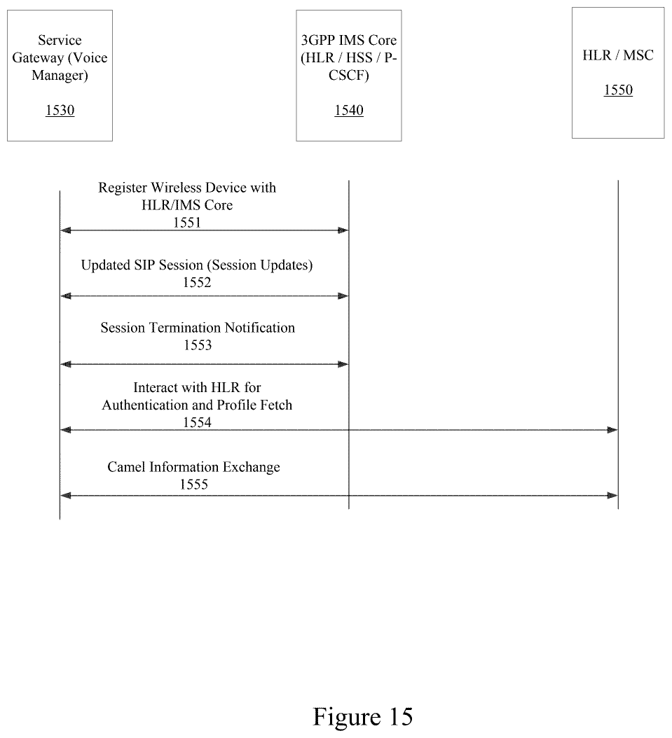

FIG. 15 shows processes between the voice manager and the service provider core components during registration and session maintenance, according to an embodiment. More specifically, FIG. 15 shows processes between the voice manager of the service gateway 1530, the 3GPP core 1540, and HLR/MSC components 1550. This includes registering, by the voice manager, wireless devices with IMS core components 1540 during session initiation, according to an embodiment. For an embodiment, the voice manager of the service gateway 1530 is configured to register 1551 wireless devices with IMS core components, including HSS and P-CSCF, during session initiation. Further, the voice manager of the service gateway 1530 is configured to manage session updates 1552 and terminations 1553 using SIP signaling. Further, the voice manager of the service gateway 1530 is configured to register the wireless devices with SS7 components, including HLR and MSC/SBC 1550, during session initiation. For an embodiment, the voice manager creates and receives SIP messages on behalf of wireless device and can act as a wireless device proxy for the service provider components. The voice manager of the service gateway 1530 interacts with the HLR 1550 for authentication and profile fetch. Further, the voice manager of the service gateway 1530 exchanges camel information with the HLR 1550 for authentication and profile fetch.

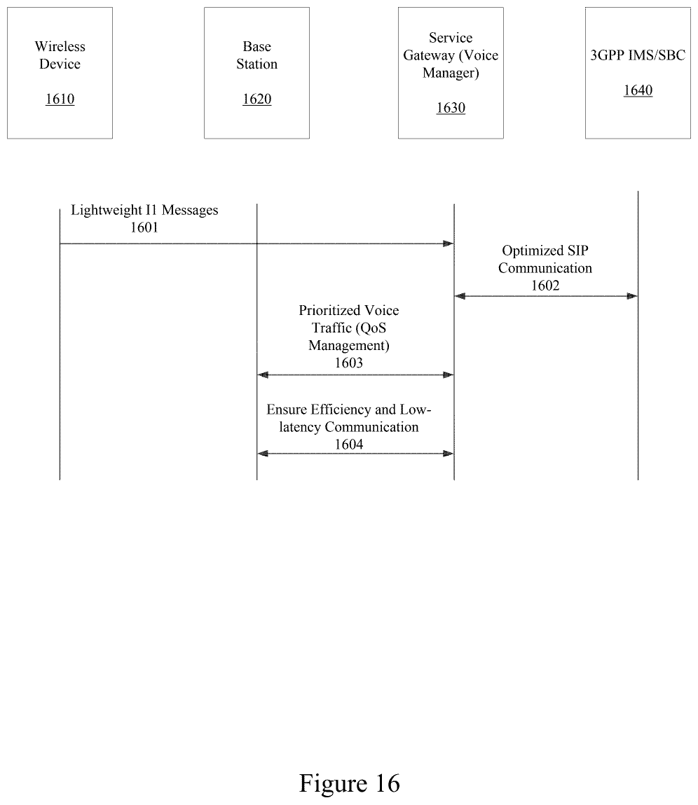

FIG. 16 shows message protocols and messages used between the wireless device 1610, the base station 1620, the voice manager of the service gateway 1630, and 3GPP IMS/SBC 1640, according to an embodiment. For an embodiment, the voice manager is configured to reduce signaling overhead by leveraging lightweight protocol messages for session initiation and maintenance. For an embodiment, the voice manager generates the keep alive messages and message response to maintain the session with the service provider, hence reducing the signaling messages between voice manager and wireless device. For at least some embodiments, the lightweight protocol 1601 between voice manager and wireless device 1610 is designed such that frequent keep-alive messages are not required between wireless device and voice manager. For an embodiment, the voice manager is configured to reduce power consumption during protocol translation by eliminating redundant IP stack elements within the voice manager. For an embodiment, the voice manager further reduces the size of messages by optimizing 1602 the lightweight protocol header. One such example includes converting the messages into a non-IP format and eliminating the IP header. For an embodiment, the voice manager is configured to maintain Quality of Service (QoS) by prioritizing 1603 voice traffic over data traffic during transmission over satellite links. Further, the voice manager is configured to ensure efficiency and low-latency communication 1604.

Although specific embodiments have been described and illustrated, the embodiments are not to be limited to the specific forms or arrangements of parts so described and illustrated. The embodiments described are to only be limited by the claims.

What is claimed:

1. A method of managing an interface of a satellite network between a wireless device and a
service provider, comprising:
receiving through a satellite link, by a service gateway of the satellite network, a wireless device trigger message from the wireless device, wherein the satellite network includes a base station and a satellite core network; and
performing, by the service gateway of the satellite network, session establishment of the wireless device with the service provider when receiving the wireless device trigger message, including modifying the wireless device trigger message to include additional data required by the service provider.

2. The method of claim 1, wherein the wireless device trigger message does not include at least some mandatory data required by the service provider for session establishment with the service provider, and wherein the service gateway of the satellite network supplements the wireless device trigger message with the at least some mandatory data.

3. The method of claim 1, wherein
receiving through the satellite link the wireless device trigger message from the wireless device comprises a voice manager of the service gateway receiving a lightweight protocol INVITE message transmitted from the wireless device; and wherein
performing the session establishment of the wireless device with the service provider when receiving the wireless device trigger message comprises translating, by the voice manager, the lightweight protocol INVITE message into a Session Initiation Protocol (SIP) INVITE message, wherein the voice manager is implemented within the satellite core network to enable compatibility with the service provider, and the voice manager further implements a translation between lightweight protocol and 3GPP (3rd Generation Partnership Project) defined CS-Voice/IMS-SIP (Circuit-Switch-Voice/IP (Internet Protocol) multimedia services-Session Initiation Protocol) protocols to enable compatibility with the service provider.

4. The method of claim 1, further comprising:
establishing, by the voice manager, SIP or SS7 (signaling system) registration for the wireless device with a 3GPP IMS core network or SS7 network, wherein the registration involves communication with network components, including a Home Subscriber Server (HSS), Proxy Call Session Control Function (P-CSCF), or Home Location Register (HLR).

5. The method of claim 4, further comprising maintaining, by the voice manager, session continuity by exchanging periodic signaling messages between the wireless device and the service provider.

6. The method of claim 3, wherein managing the interface of the satellite network between the wireless device and the service provider comprises interworking between the lightweight protocol and SIP protocols in NB-IoT (NarrowBand-Internet of Things) networks, comprising:
interfacing, by the voice manager, with 3GPP network components for session establishment and data flow management;
translating, by the voice manager, lightweight protocol messages into SIP-compliant messages, wherein the translation includes mapping media parameters via Session Description Protocol (SDP) for codec (compression, decompression) negotiation and session setup; and
performing, by the voice manager, codec translation, wherein lightweight codecs optimized for NB-IoT are converted into standard Real-Time Protocol (RTP) codecs compatible with terrestrial IMS core networks.

7. The method of claim 6, further comprising:
exchanging, by the voice manager, media parameters during session negotiation using SDP, ensuring compatibility between low-bandwidth NB-IoT codecs and terrestrial IMS codecs; and
handling, by the voice manager, low-bandwidth constraints of the satellite network by optimizing message sizes and reducing protocol overhead between the wireless device and the satellite network.

8. The method of claim 7, further comprising:
negotiating, by the voice manager, codecs for media transmission during session setup using SDP parameters, wherein, the negotiation ensures compatibility between lightweight NB-IoT codecs and codecs supported by the service provider;
encapsulating, by the voice manager, media data encoded with low-bandwidth NB-IoT codecs into voice streams for delivery to the service provider.

9. The method of claim 8, further comprising:
terminating, by the voice manager, a session upon receiving a SIP BYE message from a voice network or an IMS core network;
translating, by the voice manager, the SIP BYE message into a lightweight protocol BYE message for transmission to the wireless device, ensuring session termination consistency.

10. The method of claim 3, further comprising:
maintaining asynchronous communication between the voice manager and the service provider and voice manager and wireless device, thereby ensuring seamless interoperability between the satellite network and a terrestrial voice network or IMS core networks by maintaining compatibility across protocol layers.

11. The method of claim 10, further comprising:
supporting, by the voice manager, low-bandwidth codecs optimized for NB-IoT;
translating, by the voice manager, low-bandwidth codecs into standard codecs used in RTP streams for SIP-based communication networks.

12. The method of claim 11, further comprising:
registering, by the voice manager, wireless devices with IMS core components, including HSS and P-CSCF, during session initiation;
managing, by the voice manager, session updates and terminations using SIP signaling; and
registering, by the voice manager, wireless devices with SS7 components, including HLR and MSC (Mobile Switching Center)/SBC (Session Border Controller), during session initiation.

13. The method of claim 12, further comprising:
reducing, by the voice manager, signaling overhead by leveraging lightweight protocol messages for session initiation and maintenance;
eliminating, by the voice manager, redundant IP stack elements within the voice manager while sending the messages to the wireless device using lightweight protocol; and
maintaining, by the voice manager, Quality of Service (QoS) by prioritizing voice traffic over data traffic during transmission over satellite links.

14. The method of claim 2, wherein the wireless device trigger message is transmitted by the wireless device using a non-IP data transport layer, and wherein the mandatory data added by service gateway includes at least one of a TCP (Transmission Control Protocol) IP (internet protocol), a UDP (User Datagram Protocol) IP, or a SCTP (Stream Control Transmission Protocol) IP.

15. The method of claim 3, further comprising:
receiving through the satellite link, by the service gateway, wireless device communication messages from the wireless device;
converting, by the service gateway, the wireless device communication messages received from the wireless device into a 3GPP defined messages; and
forwarding the 3GPP defined messages to the mobile carrier network after the registration is completed.

16. The method of claim 1, wherein the wireless device trigger message causes a voice call over an NB-IoT network to be initiated, and further comprising converting, by the service gateway, a mobile network trigger message received from the wireless device into a 3GPP defined voice trigger equivalent message.

17. The method of claim 16, wherein converting the mobile network trigger message received from the service provider into the lightweight protocol equivalent message eliminates at least an IP stack and other mandatory data required by terrestrial mobile networks to enable voice and multimedia communication.

18. The method of claim 1, wherein the wireless device trigger message is defined by a lightweight protocol between the wireless device and the service gateway, and functions of the service gateway include interworking between the lightweight protocol and a 3GPP SIP protocol, wherein interworking includes mapping between the lightweight protocol messages and standard SIP messages.

19. The method of claim 1, wherein the wireless device trigger message triggers a voice call, wherein the wireless device trigger message includes a session description protocol offer for negotiation, and the service gateway responds with a session description protocol answer.

20. The method of claim 1, further comprising:
communicating, by the service gateway, with the base station through a base station interface;
wherein base station provides a receive timestamp of voice packets to the service gateway using a base station interface, wherein the base station interface is a communication interface between service gateway and base station.

21. The method of claim 20, further comprising:
collecting, by the service gateway, information about ongoing services associated with the wireless device from both the base station interface and the service provider interface;
wherein the ongoing services include voice, streaming and other types of active services related to the wireless device.

22. The method of claim 21, further comprising:
communicating, by the service gateway, information obtained from the service provider interface, including upper-layer service information including call start and call stop events, to the base station through the base station interface;
adapting, by the base station, an air interface of the satellite network for the wireless device based on the information received from the service gateway, wherein the information pertains to the ongoing services associated with the wireless device;
initiating and terminating, by the base station, based on information received from the service gateway, configurations including one or more of initiating semi-persistent scheduling mechanism, configuration of physical channels, allocation of resources on the physical channels, and other air interface adjustments for the wireless device.

23. The method of claim 22, further comprising:
utilizing, by the service gateway, information received from the base station to trigger upper-layer modifications in response to changes in a satellite network interface; and
communicating, by the service gateway, the upper-layer modifications to the service provider, wherein the upper-layer modifications include service adjustments including stopping a service if the base station informs the service gateway of a radio-link failure experienced by the wireless device.

24. A satellite network, comprising:
a satellite;
a base station configured to communicate with a wireless device through the satellite;
a service gateway, the service gateway configured to:
receive a wireless device trigger message from the wireless device through a satellite link, wherein the satellite network includes a base station and a satellite core network; and
perform session establishment of the wireless device with the service provider when receiving the wireless device trigger message, including modifying the wireless device trigger message to include additional data required by the service provider.
